(19) United States
(12) Patent Application Publication
(10) Pub. No.: US 2026/0204103 A1
(43) Pub. Date: Jul. 16, 2026

(54) AUTOMATIC TOLL MONITORING SYSTEM AND METHOD

(71) Applicant: GEOTOLL, INC., Boca Raton, FL (US)

(72) Inventors: Jaime Andres Borras, Miramar, FL (US); Wyatt Drake Geist, Davie, FL (US)

(21) Appl. No.: 19/348,555

(22) Filed: Oct. 2, 2025

Related U.S. Application Data
(60) Provisional application No. 63/702,517, filed on Oct. 2, 2024.

(51) Int. Cl. G07B 15/06; H04L 9/40

(52) U.S. Cl. CPC G07B 15/063; H04L 63/0807

(57) ABSTRACT

A vehicle tolling system for charging tolls and/or road use charges includes a toll agency management data center that interacts with mobile device used in vehicles to track distance driven by the vehicle. An application program on the mobile device facilitates an initial registration, including gather information about the one or more vehicles to be associate with the tolling account, and the application program is further configured to ensure that the tolling is accurate. The mobile device and the data center exchange tokens to ensure that the application program is operating, and when the data center does not receive tokens or answer messages in a timely manner the data center notifies the user and can require the user to re-complete portions of the initial registration process to ensure appropriate charges are applied to the user’s account.

### CROSS REFERENCE

This application claims the benefit of provisional application no. 63/702,517, filed Oct. 2, 2024, the entirety of which is hereby incorporated by reference.

### FIELD OF THE INVENTION

The present invention relates generally to vehicular tolling systems, and more particularly, relates to monitoring user compliance with automated tolling systems that use the user’s mobile device to monitor vehicle use and toll activity.

### BACKGROUND OF THE INVENTION

Toll roadways have long been in use and have evolved from having manned toll stations along a toll route to automated, drive-by tolling. The equipment and personnel required to collect tolls has decreased, but toll agencies would like to move tolling control to be on drivers’ mobile devices to reduce costs even more. However, relying on a driver’s mobile device comes with certain issues, such as ensuring that the driver keeps their device on, and the tolling application program operational. There are numerous situations in which a driver could have their phone turned off, or the tolling application program not enabled. In a system designed to depend on driver compliance, these situations must be addressed.

Therefore, a need exists to overcome the problems with the prior art as discussed above.

### SUMMARY OF THE DISCLOSED EMBODIMENTS

In accordance with some embodiments of the inventive disclosure, there is provided a toll system that includes a mobile device operating a tolling application program, and a toll agency data center.

The toll agency data center periodically transmits a cryptographic token to the mobile device, and the mobile device returns the cryptographic token in response. When there is a delay exceeding a predetermined time period in the mobile device returning the token, the toll agency management data center prompts the mobile device to capture an image of a vehicle odometer of a vehicle using the tolling application program while the mobile device is operatively coupled to the vehicle.

In accordance with a further feature, the toll agency management data center is further configured to obtain a vehicle odometer reading of the vehicle from an original equipment manufacturer’s data center.

In accordance with a further feature, the toll agency management data center is configured to transmit a prompt to the mobile device to capture the odometer image while the mobile device is also operatively connected to a personal area network transceiver of the vehicle.

In accordance with some embodiments of the inventive disclosure, there is provided a toll system that includes a mobile device operating a tolling application program, and a toll agency data center.

When the mobile device determines that a user is logging out of the tolling application program, the tolling application program captures a snapshot of application permissions, and transmits a message to the toll agency management data center including the message which indicates the application permissions and that the user has logged out of the tolling application program. In response to the toll agency data center receiving the message, the toll agency data center transmits a message to the mobile device to prompt the user to sign back into the tolling application program.

In accordance with a further feature, when the toll agency management data center does not receive the token acknowledgement, the toll agency management data center sends a message to the user to prompt the user open the mobile application and resume permissions.

In accordance with some embodiments of the inventive disclosure, there is provided a toll system that includes a mobile device operating a tolling application program and a toll agency data center. When the tolling application determines that a permission is been removed, the tolling application program transmits a message to the toll agency management data center including the message which indicates the application permission had been removed. In response to the toll agency data center receiving the message, the toll agency data center transmits a message to the mobile device to prompt the user to enable back the removed permission into the tolling application program.

In accordance with a further feature, permissions include detecting the removal of the Bluetooth link with the vehicle in the tolling account, and wherein when there is a delay exceeding a predetermined time period in the mobile device returning the Bluetooth permission, the toll management data center prompts the toll agency that the user is not compliant.

In accordance with a further feature, when the toll agency receives the user non-compliance message, the toll agency applies to other means to collect the toll. [In the case of toll roads, it uses the automatic license plate recognition; and in the case of the road usage charge program, it charges the division of motor vehicles annual prorated rate.]

In accordance with a further feature, permissions include detecting the removal of the GNSS/GPS link with the mobile device in the tolling account, and wherein when there is a delay exceeding a predetermined time period in the mobile device returning the GNSS/GPS permission, the toll management data center prompts the toll agency that the user is not compliant.

In accordance with a further feature, when the toll agency receives the user non-compliance message, the toll agency applies to other means to collect the toll.

In accordance with some embodiments of the inventive disclosure, there is provided a toll system including a plurality of mobile devices where ach mobile device operates a tolling application program in association with a respective tolling account. There is also a toll agency data center that maintains each respective tolling account. Each mobile device is configured to detect when it is in the presence of a vehicle associated with the respective tolling account and when the vehicle has begun a trip based on a change in location of the mobile device while in the presence of the vehicle, and to determine when the trip has ended and record a location of the vehicle upon determining that the trip has ended. Each mobile device of the plurality of mobile devices is further configured to, upon detecting the commencement of a new trip, compare a location of the vehicle at the commencement of the new trip with the location of the vehicle at the end of the preceding trip, and when these locations do not sufficiently match, prompt the user to use the mobile device to capture a vehicle odometer image through the tolling application program.

In accordance with some embodiments of the inventive disclosure, there is provided a toll system including a mobile device operating a tolling application program and a toll agency data center. The mobile device is configured to connect to an external device using a low power personal area wireless networking link and continue to report location information to the toll agency data center. The toll agency data center is configured to determine a time period that the mobile device has been connected to the external device. The toll agency data center is further configured to determine that the mobile device has been connected to the external device for a threshold period of time indicating that the external device is not a component of a vehicle, and in response, prompt a user of the mobile phone to capture an odometer image of the vehicle while connected to a different external device that is assumed to be the vehicle.

Although the invention is illustrated and described herein as embodied in an automated tolling system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as "up", "down", "left", "right", "inside", "outside", "front", "back", "head", "tail" and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as "first", "second", "third" and so on are only used for descriptive purposes, and cannot be construed as indicating or implying relative importance.

In the description of the embodiments of the present invention, it should be noted that, unless otherwise clearly defined and limited, terms such as "installed", "coupled", "connected" should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. To the extent that the inventive disclosure relies on or uses software or computer implemented embodiments, the terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an overall tolling system in which there are various vehicles and mobile devices that interact with each other and a toll agency data center via public data networks, in accordance with some embodiments of the inventive disclosure.

FIG. 2 shows an exemplary dashboard interface as would be presented on a computer display or monitor, in accordance with some embodiments.

FIG. 3 shows a detail of the status tool for use in monitoring accounts in a toll account management system, in accordance with some embodiments.

FIG. 4 shows a flow chart diagram of a method for determining if a driver properly has their toll application program operating while driving.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

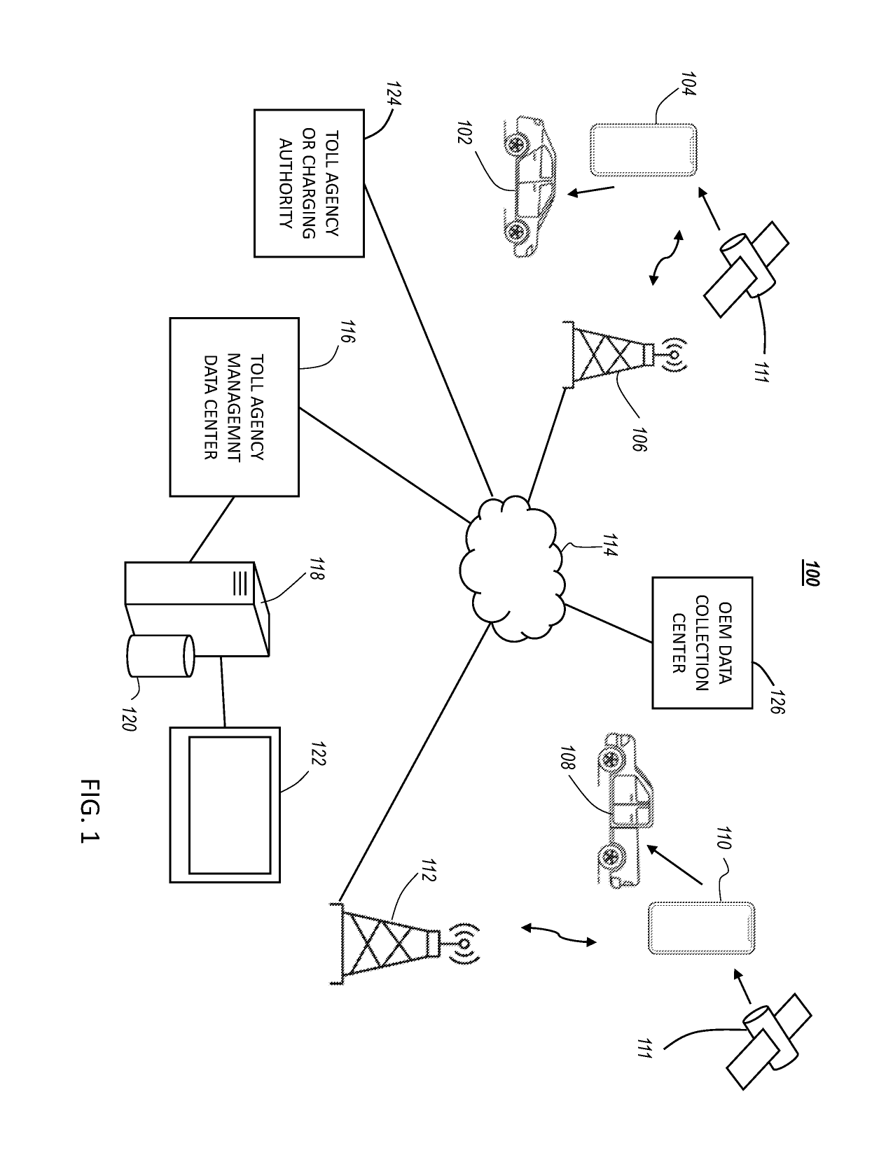

FIG. 1 is an overall tolling system 100 in which there are various vehicles and mobile devices that interact with each other and a toll agency data center 110 via public data networks, in accordance with some embodiments of the inventive disclosure. Briefly, there are numerous vehicles such as vehicles 102, 108 driving on various roadways. While traditional tolling has occurred in special restricted access roadways where vehicles had to pay a prescribed toll amount at various points along the roadway, there is also a movement by various governmental jurisdictions to move away from gasoline fuel taxes and charge a road usage fee, or road usage charge (RUC) as it is commonly referred in the industry, to vehicles using or travelling on those roads. Both traditional tolling and RUC can be carried out in the system 100 using phone-based toll application. But, as identified in the Background section, there can be issues with this approach being favored by the industry. The disclosed inventive system applies to both cases. In each vehicle 102, 108 there is a driver or other passenger who has a mobile device 104, 110. The mobile devices 104, 110 are computing devices that include a cellular telephony and data transceiver and can communicatively interact with cellular communications infrastructure such as cellular base stations 106, 112, respectively, including both voice and Internet data communication. As is well known, as the vehicle moves, the cellular connection between a mobile device and the cellular communications infrastructure can “hand off” from one base station to another base station operating an adjacent cell. Further, as is also well known, cellular communications infrastructure provides connectivity to the Internet 114. In addition, it is also well known that mobile devices 104, 110 include a receiver to receiver signals from a Global Navigation Satellite System 111 (GNSS/GPS) that provides location services by transmitting timed signals that allow the receiver to determine its position on Earth.

Each mobile device 104, 110 runs an application program that is configured to detect when it is in its associated vehicle 102, 108, and moving. The application program can also track location and distance travelled, as well as whether the vehicle is travelling on toll roads, non-toll roads, or roads subject to a RUC so that the corresponding fee(s) can be charged to the operator/owner of the vehicle 102, 108. Since the mobile device 104, 110 is principally responsible for facilitating the determination of where, and how far its respective vehicle 102, 108 has driven in order to determine the correct fee to be charged, it is imperative that the mobile device 104, 110 be in the vehicle 102, 108 and operating, in order to reduce, if not eliminate, any additional effort on the user’s part. This can be done, for example, by having the mobile device 104, 110 detect a connection to the vehicle 102, 108 in a way that uniquely identifies the vehicle 102, 108. For example, the mobile device 104, 110 can he connected to the automobile diagnostic bus (ADB) port, allowing the mobile device (executing the tolling application program) to communicate with the vehicle computer and obtain identifying information such as the vehicle identification number (VIN). Another way of identifying the vehicle is by a wireless connection to the vehicle BlueTooth interface, since the vehicle’s BlueTooth transceiver will have a unique media access controller (MAC) address. The BlueTooth connection detection method is preferred because it doesn’t require the user to do anything once the mobile device is initially paired with the vehicle audio system. BlueTooth is an example of a personal area networking (PAN) radio communications interface, and is commonly used by drivers to operate their cellular phone through the vehicle’s audio and display system, especially in jurisdictions where drivers are prohibited from manipulating or manually interacting with their phone while driving. Once the mobile device detects that it is connected to the vehicle’s audio system, and that the vehicle is moving sufficiently to indicate that the vehicle is being driven, as indicated by the GNSS receiver, the mobile device then commences location and distance tracking and reporting. The reporting is accomplished by sending reports to a toll agency management data center 116 via the internet. The user can have an account set up with the toll agency in which the vehicle information is stored, including, for example, the vehicle license number (tag number). The data center 116 includes servers and databases, among other computing equipment, such as server 118 and database 120. The server 118 can maintain a record of the vehicle’s distance driven, among other information about the vehicle’s movement, in the database 120. A dashboard 122 can allow toll agency personnel to see overall system metrics, as well as individual vehicle information and application program operation information. A dashboard is a user interface generated on a graphic display of a computing system that show specific data values for various metrics. In addition to the user’s phone sending data to the toll agency management data center 116, it is becoming increasingly common for vehicles to have their own cellular transceiver and transmit telematic data to an original equipment manufacturer (OEM) data center 126. This can include total miles driven, fuel efficiency data, location data, and so on. There can also be a tolling authority 124 with which the toll agency management data center 116 settles toll charges on behalf of account holders. The tolling authority 124 will typically be a governmental entity that is responsible for collecting the toll and RUC revenue.

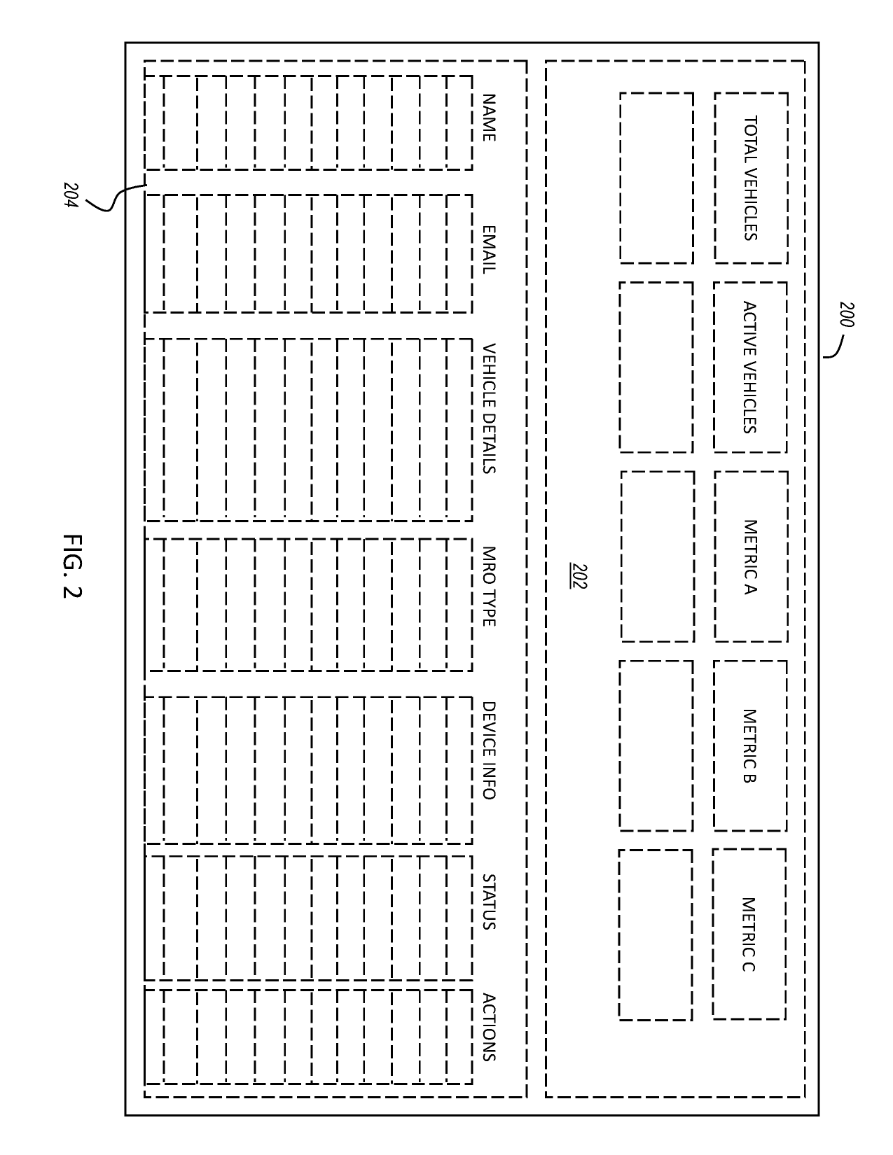

FIG. 2 shows an exemplary dashboard interface 200 as would be presented on a computer display or monitor, in accordance with some embodiments. In particular, the dashboard interface 200 shown here can be used in dashboard 122 in FIG. 1. The dashboard interface 200 can include a metrics section 202 and a status section 204. The metrics section 202 presents various metrics in a clickable menu arrangement that allows an operator (e.g. personnel of the toll agency management data center 116) to select any of the various metrics elements and get more information. Examples of metrics can include, for example, the total number of vehicles registered with the system, and the number of vehicles active at the present time. Other types of metrics that can be tracked can include, for example, accounts pending approval, accounts pending email verification, accounts pending proof of BlueTooth pairing with a vehicle, GNSS/GPS location signal availability to the toll application in the mobile device, accounts pending a VIN upload, accounts pending an odometer image upload, among others. Clicking on any of these can bring up more details and actions that can be taken. These metrics are also available to automated agents of the toll agency management data center 116, such as artificial intelligence agents that can evaluate the metrics and take actions accordingly.

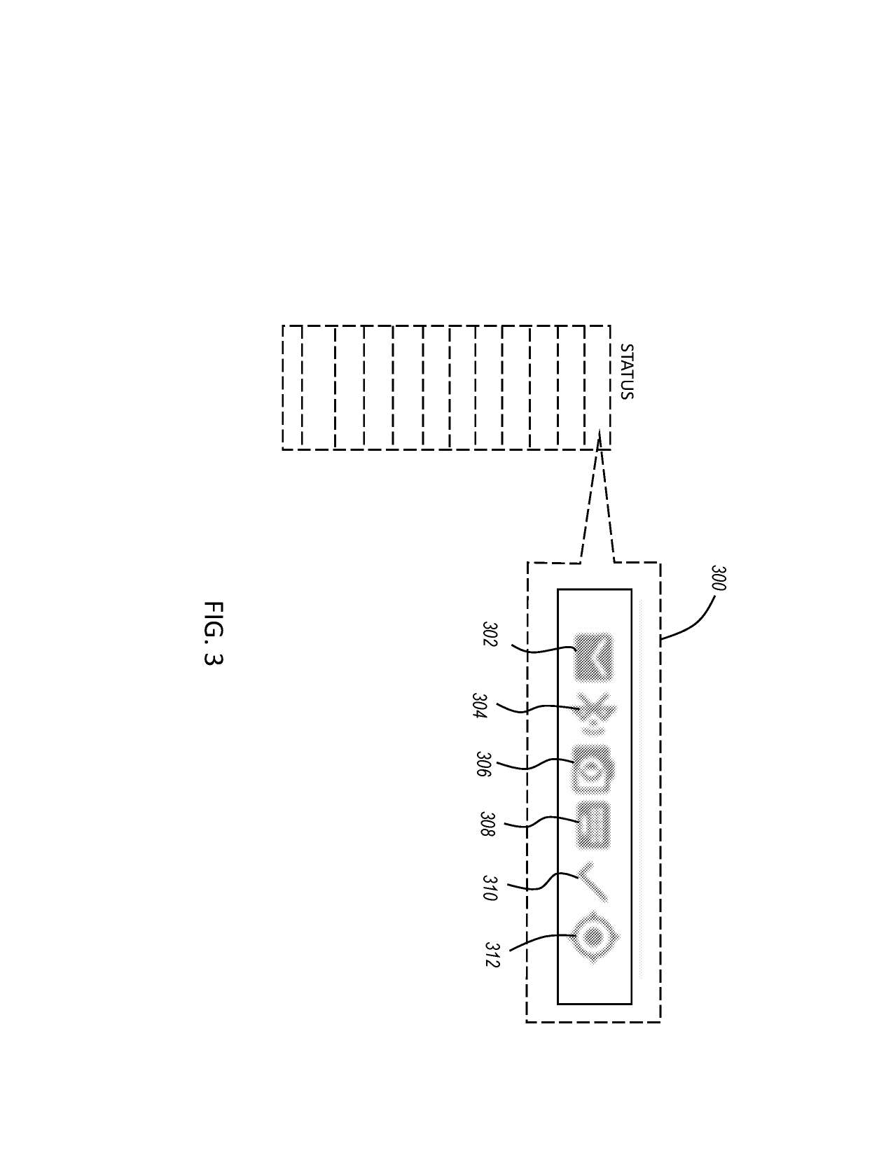

The status section 204 shows details of specific user accounts. Each row is for one account, and shows details of the status of various aspects of the account, such as the user’s name, their email, vehicle details, the mileage reporting option (MRO) device being used by that user (e.g. a permanently installed reporting device, a dongle device, or a mobile cellular telephone device), and other information. The “STATUS” column indicates the status of several key attributes of the user account, as discussed in relation to FIG. 3. The “ACTIONS” column indicates actions that can be taken to facilitate compliance with use of the system for tolling and/or miles driven reporting for charges.

FIG. 3 shows a detail of the status tool 300 for use in monitoring accounts in a toll account management system, in accordance with some embodiments. The status tool 300 shows the general compliance state for each individual account, indicating which steps to ensure compliance in having their tolling application operable when driving their vehicle to ensure proper toll or RUC billing. The tool 300 includes several clickable icons that can be displayed in the status column of the dashboard interface 200. These icons can include, for example, an email icon 302 that will show whether the account user has verified a registration email, and, by clicking on the email icon, take action to open up an email panel to send an email to the user, or simply automatically send an email. There can be a BlueTooth/PAN icon 304 to indicate whether the user’s mobile device has successfully connected to the vehicle audio system and recorded the media access controller (MAC) address, or an equivalent unique identifier of the vehicle audio system, which is used to ensure that the MRO device (e.g. the phone/mobile device or an ADB adapter) is actually in the vehicle when actions are allegedly being taken. There can be a photo icon 306 that indicates whether the user has submitted an odometer image. Other icons 308, 310, 312 can be provided for other important account parameters status, such as vehicle identification number (VIN), fully registered, downloaded application, permissions available and an icon indicating whether an account is presently active, meaning the user is driving and the tolling application is performing as designed. These can be displayed in green when the user is in compliance, and red when the user is not in compliance. Clicking on any of these can bring up more detail, as well as an action menu to select an action to remind the user of the need for compliance, such as sending an email or text message to the user’s mobile device.

There are a variety of problems that can occur in a tolling system that relies on the operator of the vehicle to have their mobile device, with the tolling application program installed and running, in the vehicle every time the vehicle is driven. Some of the issues can be unintentional or unavoidable, such as when the vehicle is driven out of cellular service areas, when the mobile device loses or is unable to receive satellite location signals, when the operator forgets to turn the mobile device on, doesn’t realize the battery charge has run out, or simply forgets to bring the device, as some examples. Other issues may be more intentional, such as the operator intentionally exiting the tolling application program or deleting the application program or disabling the permissions of the tolling application program (e.g. permission to access the devices resources for location, BlueTooth, etc.), connecting the mobile device to another BlueTooth device instead of the vehicle audio system when setting up the account and the application program in an attempt to avoid toll charges. The disclosed system is capable of identifying such issues and remedying them so that due tolling charges can be collected, as is required in the applicable jurisdiction.

A first problem is related to distance driven. Whenever the mobile device is active, and has determined that it is in the vehicle, it is active in making location determinations using satellite location signals (e.g., GNNS/GPS). Just the mobile device, via the tolling application program, is able to detect when it is in the vehicle and a trip has begun, the mobile device is also able to determine when a trip has terminated; the location will remain constant, and the mobile device will lose contact with the vehicle (e.g., BlueTooth connection ceases). When this happens, the mobile device records the location where it is when it has made the determination that the trip has ended. In the future, when the mobile device next determines that a new trip has commenced, the location of where the new trip has started with the location where the immediately previous trip ended are compared (i.e. at the mobile device or at the toll agency data center). If these locations do not sufficiently match, then it is assumed that the vehicle had an unrecorded trip. When there is a location mismatch, the mobile device permissions related to the tolling application program are collected (snapshot) and transmitted to the toll agency management data center. The toll agency management data center will then issue a prompt to the mobile device requiring the user to take a photograph of the odometer of the vehicle. The photo is taken under conditions indicating that the mobile device is in the vehicle, such as by determining that the BlueTooth transceiver of the mobile device is coupled to the BlueTooth transceiver of the vehicle. This can be enforced through various means, including reporting the driver to the vehicle authority of the appropriate jurisdiction if compliance is not timely achieved. Once the odometer image is acquired and sent to the toll agency data center, the distance driven by the vehicle can be updated, and then distance and location tracking can resume normally.

Another problem that may occur is when the user logs out of the tolling application program or deletes the tolling application program in an attempt to prevent distance driven information from being collected and used to charge the user. To address this issue, the toll agency management data center periodically generates a cryptographic token (an encrypted data structure) and transmits it to the mobile device. Normally the token is received at the mobile device as a background process, and the mobile device responds by sending the token, and encrypted answer, or both, back to the toll agency management data center (e.g. 116 of FIG. 1). These messages form the mobile device can indicate a time of day when the message is sent. If the user logs out of the tolling application program, the application program will note the time and date of the log out and alert the toll agency data center. The toll agency management data center can then transmit a message to the mobile device, such as by a text message, to indicate to the user that they have logged out of the tolling application program, request they log back in to resume accurate tolling operation. On the other hand, when the user deletes or uninstalls the tolling application program (or forces it to stop running), then it will not return a token. If a token is not returned with a given monitoring period, or if the token that is returned has an age that is older than the monitoring period, the toll agency data center will assume that the tolling application program has or had been deleted or otherwise forced to cease operating. Thus, the use of the token is a technological solution to determining when a user has attempted to obviate the tolling application program tracking driving distance and location by removing the application program or forcing it to stop operating. When this occurs, the data center will notify the user that the user must submit a new odometer image. As in the previous example, the odometer image must be captured using the tolling application program via the camera of the mobile device, while the mobile device has an assurance that it is in the vehicle (e.g. a BlueTooth connection to the vehicle). The odometer image is then sent to the toll agency management data center for processing and will include metadata such as the time/date, the location, and any other suitable metadata that can be used to verify the image as being legitimate. The odometer value (indicating total distance driven by the vehicle) is extracted from the image and compared to a record of the vehicle and distance tracked. Since a similar odometer image is required to set up the account for the vehicle, and the total distance drive is tracked by locations fixes performed by the mobile device, a record indicating the total distance known to be driven by the vehicle can be kept. When the new odometer image indicates a value higher than this, the discrepancy can be added to the record as chargeable distance, and then the odometer value maintained by the toll agency data center is updated with the new value, where it is modified as new location information is received from the mobile device.

Yet another issue that can arise is when the user attempts to spoof a connection to the vehicle upon setting up the tolling account for the vehicle. The account set up process involves the mobile device, using the tolling application program, to capture an odometer image of the vehicle and the VIN, while the mobile device is also connected to the vehicle audio system (e.g. a BlueTooth connection). If it becomes known that the mobile device detects when the vehicle is moving by determining that it is again connected to the same BlueTooth connection, such as by getting the MAC address of the device to which it was connected, then bad actors may try to frustrate the tolling operation by, for example, allowing the mobile device to connect to some other device other that the vehicle audio system, such as a headphone set, for example. Thus, whenever the tolling application program indicates that it has been connected continuously to a device for an extended period of time, it can be assumed that it was not connected to a vehicle. Even on long, extended trips, the vehicle will be shut off; to refill with fuel, at rest stops, etc. Being continuously connected to a device for an unusually long period indicates that the mobile device is not likely connected to the vehicle, and was instead connected to some other device. When this occurs, the data center can send a message to the mobile device, requiring the user re-connect to the vehicle. If the same MAC address is encountered, the mobile device may reject it. In some embodiments the data center may include a database of OEM manufacturers who make audio systems for automobiles with listings of MAC addresses that have been deployed in automobile systems, allowing the data center to cross reference the MAC address detected by the mobile device with those provided by manufacturers to the toll agency. If there is a match, then the MAC address detected by the mobile device can be considered valid.

In addition to the use of mobile devices, it is contemplated that other devices can function equivalently. For example, rather than relying on a mobile device, the operator of the vehicle may instead choose to have an equivalent device installed in the vehicle, such as by connecting it to the ADB port in the cabin of the vehicle. Such a device can be a standalone device with its own GPS receiver to determine location, as well as a cellular data transceiver to transmit data and messages to the toll agency management data center as well as receive data and messages from the toll agency management data center. Alternatively, a device connected to the ADB vehicle port can tether to a cellular phone device running a tolling application program that uses the ADB “dongle” to confirm that the vehicle is running, or not, as well as the vehicle information (e.g. VIN) while the cellular phone device communicates with the toll agency management data center. In other embodiments there can be a device permanently mounted in the vehicle that is a “standalone” device, that is able to communicate with the vehicle computer as well as receive satellite positioning signals and communication over cellular networks.

In another scenario with the advent of connected vehicles equipped to transmit telematic and diagnostic data to their respective OEMs (Original Equipment Manufacturers) data centers, the odometer reading can be obtained from the OEM data center. That is, for example, the tolling agency management data center 116 can contact the OEM data center 126, to confirm that the MAC address received by the tolling agency management data center 116 is valid for the user’s vehicle, based on a description of the vehicle (such as brand, make and model, VIN, or any other relevant vehicle-identifying information provided by the user).

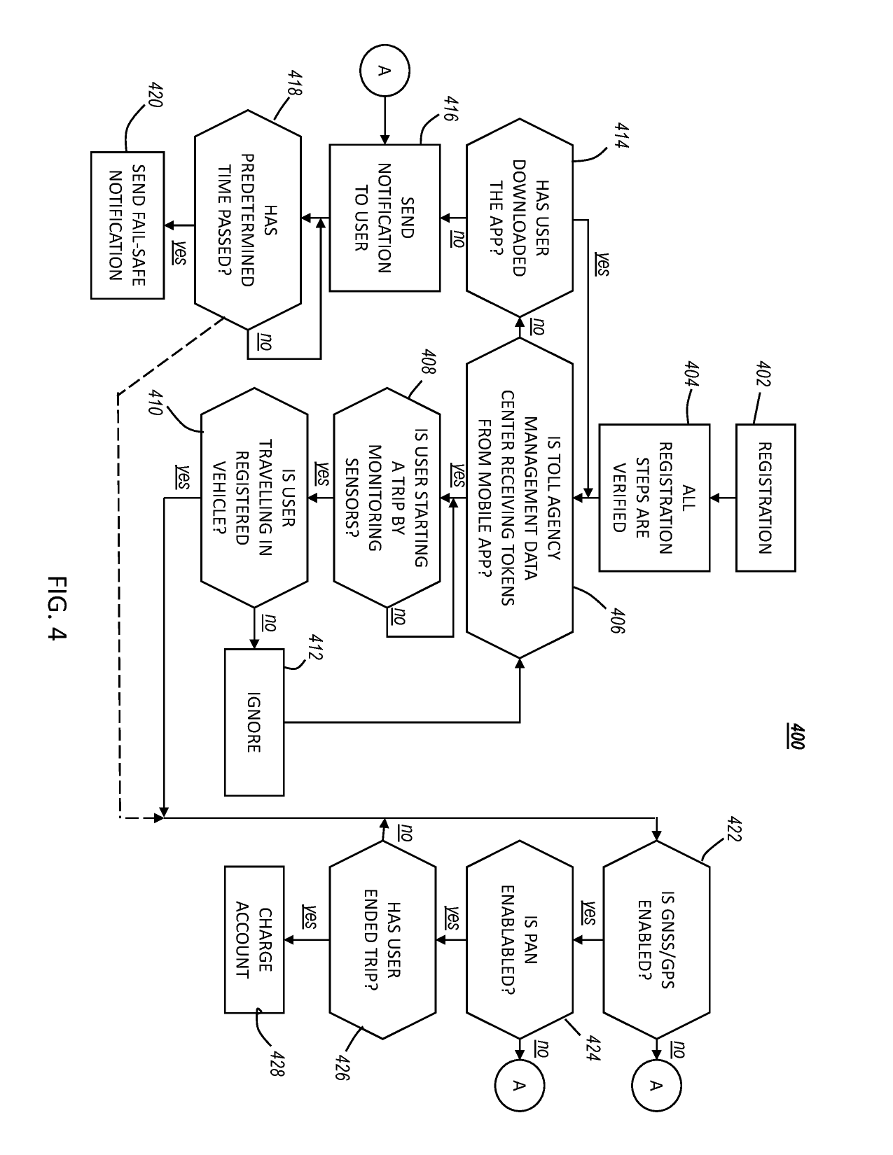

After a predetermined amount of time of the automatic tolling monitoring system detecting a registered user no longer in compliance, the system fail-safe process of FIG. 4 informs the tolling agency or charging authority (e.g 124) for their use of “other means” to collect the tolling charges overdue. Other means may include, in the case of toll roads equipped with cameras, the toll agency uses automatic license plate recognition (ALPR) technology to identify the user; and in the case of a road usage charge (RUC) program, the toll agency or authority can charge the user for the miles driven using a prorated rate based on the maximum DMV (Department of Motor Vehicles) annual fee.

The method 400 of the fail-safe process includes the initial registration step 402 in which the user has downloaded a copy of the tolling application program, installed it on their mobile device, associated it with their tolling account, and completed the vehicle information process, including having the mobile device connect, via a PAN link, to the vehicle’s audio/entertainment/display system, as well as any other requirements such as taking and transmitting an odometer image while the mobile device is connected to the vehicle via the PAN interface, and indicating the MAC address of the vehicle’s audio/entertainment/display system PAN transceiver. In step 404 all of the registration steps are completed as a pre-requisite to using the tolling application program for actual tolling or the required RUC. Proceeding in the method 400 from step 404 it is assumed that not only has the user successfully registered in step 404, but also that the tolling application program has determined that the vehicle is moving. This can occur immediately after step 404, or some time later, assuming the user does not immediately start driving the vehicle after completing step 404. To determine that the vehicle is moving, the tolling application program must be running on the mobile device, and when the mobile device’s PAN transceiver indicates that it has connected to a device, the tolling application program can check to see if the MAC address of the device matches the MAC address of the PAN transceiver of vehicle’s audio/entertainment/display system. When the tolling application program has determined that the mobile device has connected to the vehicle audio/entertainment/display system, then the tolling application program obtains location data from the satellite location receiver of the mobile device, and determines, based on change in position over time, and upon this indicating a threshold speed, that the vehicle is moving. Other processes as described above can occur here as well, such as checking the starting location of the present trip with the ending location of the last recorded trip. Upon determining that the vehicle is moving, the tolling application program indicates to the tolling agency management data center that the vehicle is active, and the tolling agency management data center then begins sending the encrypted tokens to the mobile device. In response, the mobile device response with an answer by either decoding the token and transmitting the result, or some other cryptographic operation on the received token, such as creating a hash of the token and the present time at which the tolling application program has the mobile device transmit the answer. Alternatively, in some embodiments, the tolling application program may simply generate tokens of its own, without receiving any from the tolling agency management data center, and transmit them to the tolling agency management data center. The information included in, or with the token can identify the account, vehicle status, MAC address of the vehicle’s PAN transceiver, time of day, location, etc.

Thus, in step 406, the tolling agency management data center (or equivalent) determines if it is receiving tokens (or answers) from a given mobile device. If so, then in step 408 the tolling agency management data center determines whether sensors are being used, such as inertial sensors (accelerometer) on the mobile device or using the satellite location receiver of the mobile device, or both. The “no” branch out of step 408 indicates that some updating delay may occur in receiving conformation of this process occurring at the mobile device. Similarly, in step 410, the method 400 determines if the mobile device is in a vehicle that is registered with the account, such as by comparing the received vehicle’s PAN MAC address to those associated with the account. In step 412 if this is not the case, then the mobile device could be used in someone else’s vehicle, such as to play songs in the vehicle by a passenger of the vehicle, or the vehicle could be a rental vehicle which may have a different way of paying tolls and RUC. When step 410 is successful, then the method 400 proceeds to step 422 to ensure that the tolling application program has access to the resources of the mobile device. For example, in step 422, the tolling application program can confirm that it still has access to the satellite location receiver of the mobile device. If the user has removed permission for this, for example, then the method follows the “A” branch to step 416 and a message is sent to the mobile device to alert the user to ensure the tolling application has access to the location service of the mobile device. In step 424 if the mobile device indicates that the PAN link is no longer enabled, and the vehicle is still moving, then again, the method 400 proceeds the step 416 to notify the user to ensure the mobile device is connected to the vehicle’s PAN transceiver. But in step 426, if the vehicle is no moving, as indicted by the location over time, it can be assumed that the loss of the PAN connection is due to the vehicle being turned off, and the trip has ended, in which case the correct charge is determined in step 428 and applied to the user’s account for settlement.

Once the method is at step 416, then it proceeds to step 418 where a predetermined period of time is given for the user to remediate the identified issue. If this does not occur in time, then the fail-safe process must occur and the user is so notified. When this happens the toll authority may use, for example, a “toll by plate” process to identify the vehicle and charge a maximum rate. This would be an attempt to incentivize drivers to ensure that they have their tolling application program properly enable with the resources needed. When the problem is resolved from step 418, then it can proceed to step 422.

It is contemplated, in some embodiments, that in step 404 the registration could be completed in another manner, such as by the user using a desktop computer and setting up an account, or at least initializing an account. If no tokens are received, it could be due to the tolling application program not having been downloaded and installed yet, so in step 414, the data center may query the mobile device. If no answer is received, it can be assumed that the tolling application program is not active (such as by not having been installed, or having been force-stopped). This can result in a message being sent to the user via step 416 to address this deficiency. If the tolling application program is enable, and responds, returning to step 406, if tokens are not being received yet, then on a second loop between steps 406, 414, the method may proceed to step 416 and transmit a message that the user may need to reinstall the application program due to data corruption or some other error.

What is claimed is:

1. A toll system, comprising:
a mobile device operating a tolling application program;
a toll agency data center;
wherein the toll agency data center periodically transmits a cryptographic token to the mobile device, and the mobile device returns the cryptographic token in response; and
wherein when there is a delay exceeding a predetermined time period in the mobile device returning the token, the toll agency management data center prompts the mobile device to capture an image of a vehicle odometer of a vehicle using the tolling application program while the mobile device is operatively coupled to the vehicle.

2. The system of claim 1, further comprising the toll agency management data center is configured to obtain a vehicle odometer reading of the vehicle from an original equipment manufacturer's data center.

3. The system of claim 1, wherein the toll agency management data center is configured to transmit a prompt to the mobile device to capture the odometer image while the mobile device is also operatively connected to a personal area network transceiver of the vehicle.

4. A toll system, comprising:
a mobile device operating a tolling application program;
a toll agency data center;
wherein when the mobile device determines that a user is logging out of the tolling application program, the tolling application program captures a snapshot of application permissions, and transmits a message to the toll agency management data center including the message which indicates the application permission and that the user has logged out of the tolling application program; and
in response to the toll agency data center receiving the message, the toll agency data center transmits a message to the mobile device to prompt the user to sign back into the tolling application program.

5. The toll system of claim 4, wherein, when the toll agency management data center does not receive the token acknowledgement, the toll agency management data center sends a message to the user to prompt the user open the mobile application and resume permissions.

6. A toll system, comprising:
a mobile device operating a tolling application program;
a toll agency data center;
wherein when the tolling application determines that a permission is been removed, the tolling application program transmits a message to the toll agency management data center including the message which indicates the application permission had been removed; in response to the toll
agency data center receiving the message, the toll agency data center transmits a message to the mobile device to prompt the user to enable back the removed permission into the tolling application program.

7. The method of claim 6, wherein permissions include detecting the removal of the Bluetooth link with the vehicle in the tolling account, and wherein when there is a delay exceeding a predetermined time period in the mobile device returning the Bluetooth permission, the toll management data center prompts the toll agency that the user is not compliant.

8. The method of claim 7, wherein when the toll agency receives the user non-compliance message, the toll agency applies to other means to collect the toll. [In the case of toll roads, it uses the automatic license plate recognition; and in the case of the road usage charge program, it charges the division of motor vehicles annual prorated rate.]

9. The method of claim 6, wherein permissions include detecting the removal of the GNSS/GPS link with the mobile device in the tolling account, and wherein when there is a delay exceeding a predetermined time period in the mobile device returning the GNSS/GPS permission, the toll management data center prompts the toll agency that the user is not compliant.

10. The method of claim 7, wherein when the toll agency receives the user non-compliance message, the toll agency applies to other means to collect the toll.

11. A toll system, comprising:
a plurality of mobile devices, each mobile device of the plurality of mobile devices operating a tolling application program in association with a respective tolling account;
a toll agency data center that maintains each respective tolling account;
wherein each mobile device of the plurality of mobile device is configured to detect when it is in the presence of a vehicle associated with the respective tolling account and when the vehicle has begun a trip based on a change in location of the mobile device while in the presence of the vehicle, and to determine when the trip has ended and record a location of the vehicle upon determining that the trip has ended; and
wherein each mobile device of the plurality of mobile devices is further configured to, upon detecting the commencement of a new trip, compare a location of the vehicle at the commencement of the new trip with the location of the vehicle at the end of the preceding trip, and when these locations do not sufficiently match, prompt the user to use the mobile device to capture a vehicle odometer image through the tolling application program.

12. A toll system, comprising a mobile device operating a tolling application program;
a toll agency data center;
wherein the mobile device is configured to connect to an external device using a low power personal area wireless networking link and continue to report location information to the toll agency data center;
wherein the toll agency data center is configured to determine a time period that the mobile device has been connected to the external device; and
wherein the toll agency data center is further configured to determine that the mobile device has been connected to the external device for a threshold period of time indicating that the external device is not a component of a vehicle, and in response, prompt a user of the mobile phone to capture an odometer image of the vehicle while connected to a different external device that is assumed to be the vehicle.
